(19) United States
(12) Patent Application Publication
(10) Pub. No.: US 2017/0134530 A1
(43) Pub. Date: May 11, 2017

(54) System and method of registering for a building account on an application software that dynamically generates individual accounts for each unit/suit in the building

(71) Applicant: Hizkias Belayneh Neway, Silver Spring, MD (US)

(72) Inventor: Hizkias Belayneh Neway, Silver Spring, MD (US)

(73) Assignee: GojoManager LLC, Silver Spring, MD (US)

(21) Appl. No.: 14/933,794

(22) Filed: Nov. 5, 2015

(51) Int. Cl. H04L 29/06; G06F 3/0481; G06F 17/30

(52) U.S. Cl. CPC H04L 67/42; G06F 17/30312; G06F 3/0481

(57) ABSTRACT

A system and method for registering a building account that dynamically generates individual accounts for each of the units in the building is disclosed.

### BACKGROUND

This invention relates to software that allows for communication between the occupants of units in a building and a central manager. The software being one provided as a service (SaaS), allows for new customers to register for a building account. This invention encapsulates the registration process for a new building account.

### SUMMARY

A system and method for dynamically generating an account for each unit/suite in a building, upon building registration, is provided. Upon registering for a building account, the user is prompted to provide parameters that will be used to generate a user account for each of the units/suits within the building. These parameters, along with a randomly generated id for the building are passed to an algorithm, which then uses these parameters to dynamically generate user accounts for each of the units in the building that is being registered. The new building account and the dynamically generated unit/suite accounts are then saved to a datastore.

### BRIEF DESCRIPTION OF DRAWINGS

FIG. 1 is a high level flow diagram illustrating an embodiment of the process for registering a new building account.

FIG. 2 is detailed diagram illustrating the building registration algorithm.

### DETAILED DESCRIPTION OF THE INVENTION

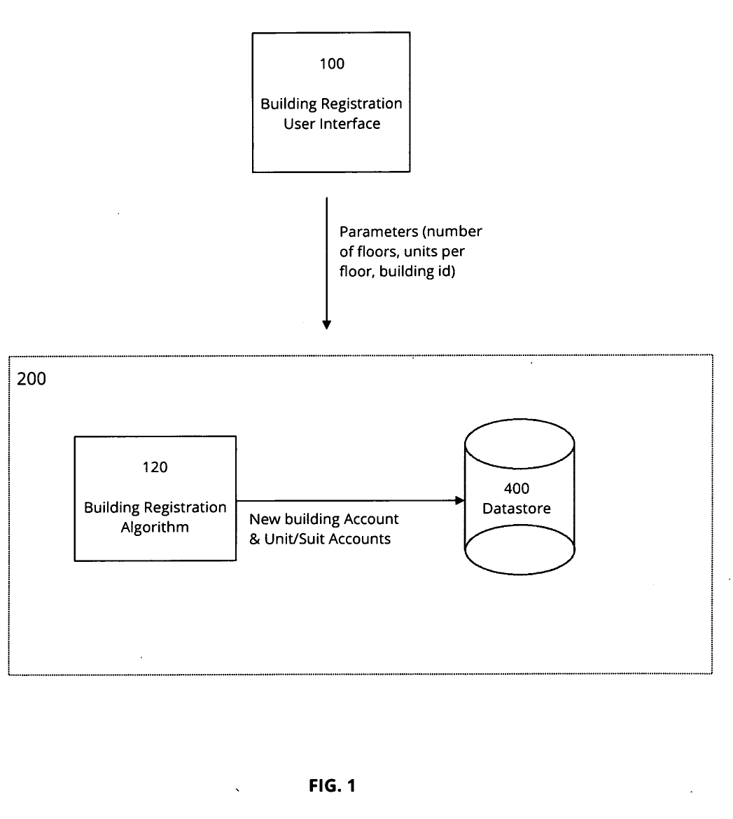

An embodiment is represented by FIG. 1. 100 is a user interface being displayed on a computing device. An example of this could be a user interface displayed on web browser as website or a user interface displayed on a mobile device. 200 is a web server, made up of web server software, for example, an Apache or Node server, running on a hardware server. 120 is code, which contains the algorithm for the dynamic generation of unit/suite accounts. 400 is a datastore, which could be comprised of a MYSQL relational database or a non-relational database such as MongoDB.

In this embodiment, an applicant fills out a registration form on user interface 100. On the form, the user is prompted to enter two parameters that will be used to dynamically generate an individual account for every unit in the building. The two parameters are the number of floors in the building and the number of units per floor. If the number of units per floor is varies, the user is prompted to enter the highest value among the variations.

Once the applicant submits the form, a building id is automatically generated and sent to web server 200 as a parameter along with the two parameters provided by applicant. Code 120 receives the three parameters on web server 200.

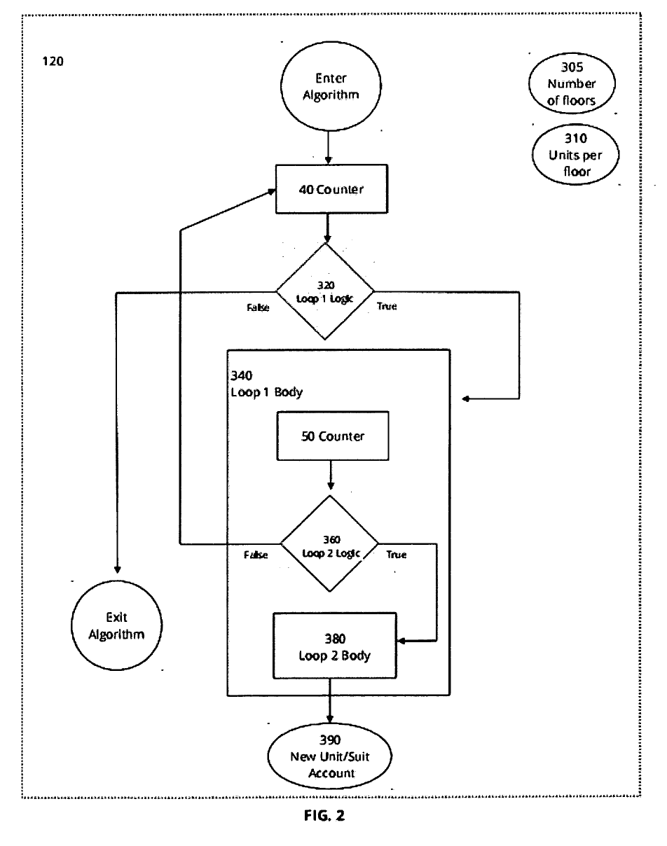

FIG. 2 illustrates the algorithm that is executed in code 120. The algorithm begins by initializing loop counter 40 to the value of 1. Alternatively, loop counter 40 may be initialized to the value of parameter 305, which is the number of floors in the building. In the scenario where loop counter 40 is initialized to the value of 1, logic 320 checks if loop counter 40 is less than or equal to parameter 305. In the alternative scenario where loop counter 40 is initialized to parameter 305, logic 320 checks if loop counter 40 is greater or equal to 1.

If logic 320 evaluates to false, the algorithm exits. If logic 320 evaluates to true, the algorithm enters into loop body 340. In loop body 340, loop counter 50 is initialized and sent to logic 360. In the scenario where loop counter 50 is initialized to 0 and the value of parameter 310 is 1, logic 360 checks if loop counter 50 is less than parameter 310, which is the number of units per floor. In the scenario where loop counter 50 is initialized to 0 and the value of parameter 310 is greater than 1, logic 360 checks if loop counter 50 is less than or equal to parameter 310. In the alternative scenario where loop counter 50 is initialized to the value of parameter 310, and the value of parameter 310 is 1, logic 360 checks if loop counter 50 is greater than 0. If loop counter 50 is initialized to the value of parameter 310, and the value of parameter 310 is greater than 1, logic 360 checks if loop counter 50 is greater than or equal to 0.

If logic 360 evaluates to false and loop counter 50 was initialed to the value of 1, loop counter 50 is incremented by 1 and the algorithm is redirected back to logic 340. If logic 360 evaluates to false and loop counter 50 was initialed to the value of parameter 310, loop counter 50 is decremented by 1 and the algorithm is redirected back to logic 340. If logic 360 evaluates to true, the algorithm enters loop body 380.

In loop 380, loop counters 40 and 50 are used to generate a unit number. This is done by multiplying the value of loop counter 40 (current floor) by 100 and adding the value of loop counter 50 to the result. Then the new unit is sent to data store 400 with the unit number, building id, a randomly generated password, vacancy status of the unit, parameters associated with notification counters, and miscellaneous data associated with the unit. Then the algorithm returns to loop logic 360.

Here is a code sample:

for ($floor = 1; $floor <= $floors; $floor++) {

for($unitCounter = 0; $unitCounter <= $unitsPerFloor;
$unitCounter++){

$unit = $unitCounter + (100*$floor);
//generate random password
//save to data store

}

}

Please note that logic 320 and 360 can be swapped to produce the same results.

for($unitCounter = 0; $unitCounter <= $unitsPerFloor; $unitCounter++){

for ($floor = 1; $floor <= $floors; $floor++) {

$unit = $unitCounter + (100*$floor);
//generate random password
//save to data store

}

}

Also please note that the logic code 120 could be executed on the client side.

1. System and method of dynamically generating unit accounts upon building registration, comprising:
a web server comprising a datastore;
a computing device displaying a user interface for building registration;

2. The system and method of claim 1, where the computing device is a computer.

3. The system and method of claim 1, where the computing device is a mobile device.

4. The system and method of claim 1, where the user interface is displayed on a web browser.

5. The system and method of claim 1, where the user interface is displayed on a mobile application.

6. The system and method of claim 1, where the logic to generate a new unit is executed on a server.

7. The system and method of claim 1, where the logic to generate a new unit is executed on a computing device.

8. The system and method of claim 1, where the datastore is a relational database.

9. The system and method of claim 1, where the datastore is a non-relational database.
